(19) United States
(12) Patent Application Publication
(10) Pub. No.: US 2010/0323608 A1
(43) Pub. Date: Dec. 23, 2010

(54) System and method for preventing photography

(75) Inventors: Yosef Sanhedrai, Petah Tiqwa (IL); Ariel Schwarz, Elkana (IL); Liad Ben Yishai, Bet Lehem Haglilit (IL); Zeev Zalevsky, Rosh HaAyin (IL)

Correspondence Address: ROBERT G. LEV, 4766 MICHIGAN BLVD., YOUNGSTOWN, OH, 44505, US

(73) Assignee: Photo Free Ltd., Bnei Brak (IL)

(21) Appl. No.: 12/308,525

(22) PCT Filed: Jun. 17, 2007
(86) PCT No.: PCT/IL07/00730

§ 371 Date: Sep. 8, 2010

(30) Foreign Application Priority Data
Jun. 18, 2006 (IL) 176369

(51) Int. Cl. H04K 3/00

(52) U.S. Cl. 455/1

(57) ABSTRACT

A method for causing the localized malfunctioning of a digital camera in a specified area; (102) to degrade photographic recording by the digital camera, comprising the steps of coupling the digital camera to a source of'electromagnetic interference (104, 106) and generating electromagnetic waves (108) of a frequency to interfere with the correct functioning of at least one electronic component of the digital camera.

### FIELD OF THE INVENTION

The present invention is directed to providing a system and method for preventing unauthorized photography in specific locations.

### BACKGROUND

Photography is ever more commonplace, with many people having digital cameras on their mobile phones. In general digital cameras are phasing out traditional film based equipment. The advantages of digital photography include the compactness of the cameras, high reliability and ease of image processing and transmission via the Internet or multimedia messaging (MMS) enabling the photographer to transmit images within seconds.

Digital cameras use one of two competing image sensing technologies CMOS—Complementary Metal Oxide Semiconductor technology and CCD—Charged Couple Devices. Both technologies convert photons to electrons by the photoelectric effect, and provide electronic signals indicative of incident light levels.

In the past, the CCD technology was predominant, but now CMOS is taking over, due to its cheaper price and smaller size. CCDs have higher photosensitivity and are less affected by noise than CMOS based devices, so tend to provide higher quality images. CMOS based components not only convert photons to electrons, but also perform image processing, brim discovery and analog-to-digital conversion. Because of the sophistication, they have an inherent sensitivity to electronic noise.

In consequence of the ever wider use of digital cameras, personal privacy is invaded. Security including national security is easily breached. Censorship is ineffective as any images banned from newspapers tend to be broadcast via the Internet. Industrial espionage is rife.

Paparazzi make their living out of candidly photographing the rich and famous, often in compromised positions. Photographic images are copyright of the photographer. Occasionally it is possible to get injunctions on the basis of invasion of privacy, but by then it is usually too late. The tragic, avoidable accident wherein the much loved Princess of Wales was killed trying to avoid the paparazzi, emphasizes the seriousness of the situation.

United States Published Patent Application Number USSN 20040202382 to Pilu, titled “Image capture method, device and system” describes an image capture method for excluding portions of image on request of signal from a user-wearable device, involves receiving inhibit signal, identifying portion to be excluded and distorting relevant area. Specifically, a captured image of a scene is modified by detecting an inhibit signal emanating from an inhibitor device carried by an object within the scene. In response to receipt of the inhibit signal, identifying a portion of the image corresponding to the object. The image object of the scene is modified by obscuring the image portion of the object. The technology is essentially a face recognition and blur out feature for a CCD camera addresses the issue of the invention, which requires a special chip in the camera. It does not address the issue of preventing or distorting photography by a regular digital camera.

Pilu's application, assigned to Hewlett Packard, addresses the issue of maintaining the privacy of the rich and famous. It does not address the issue of preventing the photographing of military equipment, documents and maps, or industrial espionage.

Furthermore, Pilu's technology relies on cooperation with camera manufacturers, them being required to provide a privacy chip in their equipment. Such a solution might be potentially useful to prevent the bystander from photographing the rich and famous, but will do little to limit the activities of the paparazzi that will presumably have little difficulty in procuring cameras that do not include the face blurring facility. Consequently, Hewlett Packard are on record as stating that they have no intention of commercializing Pilu's technology.

A separate but related need to prevent photography exists where films are screened, i.e. an image is projected upon a screen by a film projector or a video projector, perhaps at a prerelease screening or the like, where there is a danger of the film being captured by a domestic camcorder smuggled in by one of the viewers. Such film piracy results in copyright infringement and may be used to provide bootleg copies of the film. There have been several attempts to address this issue.

For example, U.S. Pat. No. 6,018,374 to Wrobleski titled “Method and system for preventing the off-screen copying of a video or film presentation” relies on the principle that video camcorders are sensitive to portions of the infra red spectrum. A method and system for preventing a visible video copy being made of a projected image on a screen is described. To prevent the copying of a projected image by such a video camcorder, a focused or unfocused image in the infra red spectrum is projected on top of the visual image. This infra red image will not be visible to the audience in the theater. However a recording of the visual image by a video camcorder sensitive to the infra red spectrum will be distorted beyond use. When a focused infra red image is projected onto the screen it may include a message indicating the date and source of the recording. Other messages could be used including a message to the video pirate that he has been caught.

U.S. Pat. No. 6,674,561 to Ohnishi et al. titled “Optical state modulation method and system, and optical state modulation apparatus” describes an optical state modulation method that comprises steps of periodically modulating luminance of a visible light in a temporal domain so as to generate an optical state variation on a recorded image that is obtained by image-capturing of a displayed image, the visible light being superposed on an original display image to produce the displayed image, the optical state variation being independent of an original display image and generating no hampering effect when the displayed image is directly watched.

U.S. Pat. No. 6,742,901 to Kimura et al., titled “Imaging prevention method and system” describes an imaging prevention method for interfering with unauthorized imaging of a number of visual images projected on a screen by projecting infrared light to a viewer/audience direction from at least one or more infrared light projector devices disposed at a rear side of the screen. According to the method, an amount of infrared light is directly incident into an imaging apparatus whereby increasing the prevention effect causes more infrared light to be directly incident into the imaging apparatus of a person conducting the unauthorized act.

U.S. Pat. No. 6,771,349 to Sitrick titled “Anti-piracy protection system and methodology” describes a similar movie anti-piracy system, having sensing and reporting features. A movie projector projects a light image to reflect off of a screen, while an infrared energy projection source generates an infrared energy pattern which is reflected off the screen (or otherwise projected) in the same field of view as the light images reflecting from the screen.

US20040091110A1 to Barkans, titled “Copy protected display screen” describes a display system capable of displaying an image is modified with one or more elements that emit energy that is outside the range of human perception, but within the range that is detected by the sensors used in a mechanical recording device. This energy could be in the infrared range of the electromagnetic spectrum. With this modification the display screen will produce two simultaneous, or near simultaneous, images. The first image, seen by a human observer, will differ from the second image captured by the sensors of a recording device, such as a video camera.

WO0074366A2: “Systems And Methods for Preventing Camcorder Piracy of Motion Picture Images” describes further systems and methods for preventing piracy of motion picture images by recording the images as they are displayed on a movie screen, using a camcorder as a recording device. Two alternative anti-piracy systems and methods are described. The first method is to vary the frame rate of the displayed motion picture images in a random fashion, thus preventing the camcorder from synchronizing its internal frame rate with that of the displayed motion picture image. The second method is to transmit pulsed energy with frequencies in the frequencies of visible light, such as red light in a manner with sufficient transmitted power or frequency to degrade the quality of the recorded image by the recording device. The result is significantly degraded quality of the recorded images. The two embodiments can be used alone or in combination.

U.S. Pat. No. 6,977,366 to Light et al. titled “detecting and thwarting imaging systems at theatrical performances” relates to a piracy detecting system for protecting theatrical experience entertainments such as movies. A system and method of detecting and thwarting the use of unauthorized imaging systems at theatrical performances is described. Sensors are deployed at a theatrical event to detect the IR focusing signal and/or the RF signal of an unauthorized imaging device. De-focusing signals are used to disrupt the auto focus system of imaging devices that do not use IR focusing systems. A thwarting signal comprising invisible light frequencies may be combined to produce a thwarting signal that is received by the CCD of an imaging device as white light thereby rendering the recorded image unusable.

It will be appreciated that the photon flooding approaches are only suitable for preventing photographing a screen or similar, in a movie theatre, where the object to be filmed is clearly identified and the audience and cameras posing a threat are situated in front of the screen and are focussed on the screen, i.e. are pointing in the same direction. The systems that are based on varying the frame rate of the displayed motion picture are likewise solutions for preventing illicit recording of cinematographic projections such as films and videos which are totally inapplicable for preventing paparazzi type photography of famous people, preventing photography at military sites and industrial espionage, where the object photographed is not itself a cinematographic projection.

There is thus still a need for workable solutions that prevent digital photography of real objects, and not just projected images. Preferably such solutions will not require cooperation from the camera manufacturers. The present invention addresses this need.

### SUMMARY OF THE INVENTION

It is an aim of embodiments of the invention to provide a technology for preventing correct functioning of digital cameras in a protected location.

It is a further aim of embodiments of the invention to cause image distortion of still images and/or movie sequences taken by digital cameras in a protected location.

It is a further aim of embodiments of the invention to cause image distortion of still images and movie sequences taken by digital cameras in a restricted space.

It is a further aim of embodiments of the invention to cause image distortion of still images and movie sequences taken by digital cameras outside, but within a specific radius of a subject.

It is an aim of one embodiment, to provide a means of directing a focussed distorting wave in the direction of a suspected earner or photographer, to cause distortion of still/movie images taken in the specific direction.

In a first aspect, the present invention is directed to providing a method for causing the localized malfunctioning of a digital camera in a specified area to degrade photographic recording by the digital camera, comprising the steps of coupling the digital camera to a source of electromagnetic interference and generating electromagnetic waves of an interfering frequency that interferes with the correct functioning of at least one electronic component of the digital camera.

The digital camera may be a still camera, a video camera or a digital cameras incorporated into cell phones, for example.

The source of electromagnetic interference is typically a signal generator coupled to an antenna.

The digital camera is coupled to the source of electromagnetic interference by a coupling mechanism selected from the list of inductively coupling by a magnetic field, capacitively coupling by an electric field and radiatively coupling by an electromagnetic field.

Typically the digital camera comprising at least one photoelectric element selected from the list of CMOS and CCD elements, and the malfunctioning of the digital camera is due to malfunctioning of at least one CMOS or CCD element.

Typically, frequency of electromagnetic interference is approximately 13.6 MHz.

The method of causing the localized malfunctioning of a digital camera in a specified area may be employed in military installations, security installations, entertainment venues, proximity of a celebrity and business venues, for example.

In some embodiments, the specified location is in proximity of a person and the signal generator and transmitter are portable with that person.

In other embodiments, the specified location is fixed and the signal generator and transmitter are installed in that specified location.

In a second aspect, the present invention is directed to a method of selecting frequencies for blocking the operation of a digital camera comprising the steps of: (i) Positioning a digital camera in proximity to a transmitter, such as at an electromagnetic compatibility testing site, (ii) Transmitting electomagnetic signals stepwise through radiofrequency section of electromagnetic spectrum to identify specific radio frequencies capable of affecting functionality of the digital camera; (iii) Constructing a signal generator capable of generating waveforms at the specific radio frequencies; (iv) Constructing an antenna for transmitting the generated signals, (v) Coupling the antenna to the signal generator by a transmission line, and (vi) Adjusting signal intensity to produce appropriate blocking signals over the desired space where digital photography is to be prohibited.

Preferably the waveforms are complex waveforms.

In a third aspect of the invention, there is provided a means of interfering with the operation of a digital camera comprising the step of: (c) transmitting electromagnetic radiation that interferes with correct functioning of the digital camera.

Preferably, the method comprises the preliminary steps of: (a) locating the digital camera and (b) lining up a transmitter with the digital camera, where step (c) of transmitting an electromagnetic wave is a directed transmission towards the digital camera.

Typically, the transmitted electromagnetic radiation comprises radiation of a frequency of approximately 13.6 MHz.

Typically the transmitted electromagnetic radiation comprises white noise or complex waveforms.

A further aspect of the invention is directed to a system for interfering with correct operation of a suspected digital camera at a targeted location comprising a detecting means for detecting the target, a transmitter of blocking radiation and a directing means for directing the blocking radiation at the target.

Optionally, the detecting means comprises a listening means for detecting audible shutter clicking sounds.

Additionally or alternatively, the detecting means detects electromagnetic emissions of the digital camera.

Typically, the electromagnetic emissions are clock registry emissions of a pixilated array.

Additionally or alternatively, the detecting means comprises movement sensors.

Typically, the transmitter is a radio transmitter for transmitting radio waves.

Most typically the radio waves are MHz radio waves.

Typically, the directing means comprises a parabolic reflector.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a generalized method of the present invention;

FIGS. 2a and 2b are graphs of the spectrum analysis of a digital camera of the CCD type in off and on mode respectively, showing the camera to have a high sensitivity to 13.6 MHz noise;

FIG. 3a is a frame capture of a movie sequence showing a man siting at a desk;

FIG. 3b is the frame capture of FIG. 3a with the camera exposed to a random 13.6 MHz noise thereby blurring the video image to give a distorted image;

FIG. 4a is a still image of a document taken with the CCD camera;

FIG. 4b is a blurred still image taken by the CCD camera after exposure to random 13.6 MHz noise, and

FIG. 5 is a schematic block diagram of a preferred embodiment of the invention.

### DESCRIPTION OF THE PREFERRED EMBODIMENTS

The present invention relates to a technology for remote jamming of digital photographic equipment to prevent photography at sensitive sites.

Specifically, the electronics of the CMOS or the CCD component are jammed by a controlled radio frequency transmission causing electromagnetic interference, in contradistinction to prior art approaches detailed hereinabove that flood the photoelectric detection cells with photons, either IR or visible. The approach of the invention results in blocking the correct operation of the digital camera within a select area, regardless of the orientation of the camera, and can be used to prevent both still and video photography of a range of subjects including people, documents, and physical equipment, for example.

Despite the large number of digital cameras and camcorders commercially available, only a relatively small number of CCD and CMOS devices are manufactured by a small number of suppliers. These devices fall into distinct families and are expected to have similar behavior patterns. Thus to disrupt and block a wide range of commercially available digital cameras, it is necessary to transmit only a small number of different frequencies in a small range of defined frequencies, that can be transmitted at the same time.

Following the steps of the fundamental method described hereinbelow, blocking and disrupting the operation of digital cameras, video cameras and digital image recorders of cell phones can also be achieved.

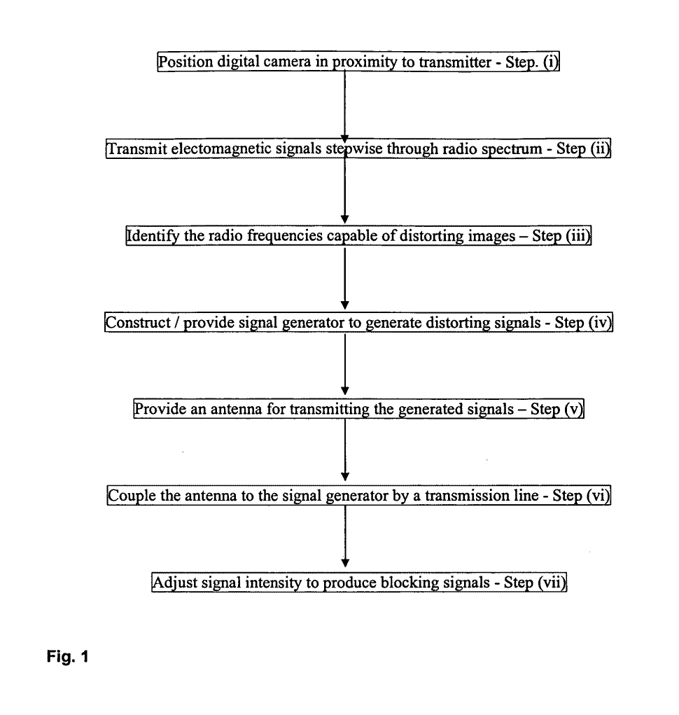

With reference to FIG. 1, the steps of the blocking method of the present invention are as follows:

(i) a digital camera is positioned in proximity to a transmitter, such as at an electromagnetic compatibility testing site.

(ii) electomagnetic signals are transmitted stepwise through the radiofrequency spectrum to identify the radio frequencies capable of distorting images.

(iii) A signal generator that is capable of generating the distorting electomagnetic signals is constructed or provided.

(iv) An antenna for transmitting the generated signals is provided.

(v) The antenna is coupled to the signal generator by a transmission line,

(vi) The signal intensity is adjusted to produce appropriate blocking signals over the location where digital photography is to be prohibited.

Optionally, the signal generator and transmitter are portable and are moved together with a celebrity to prevent illicit photography thereof. In one embodiment, the signal generator and transmitter are configured as a mobile phone.

For indoor applications, a Faraday cage may be used to define a photo free zone. Outside, directed antennas may be required to prevent photography from certain directions.

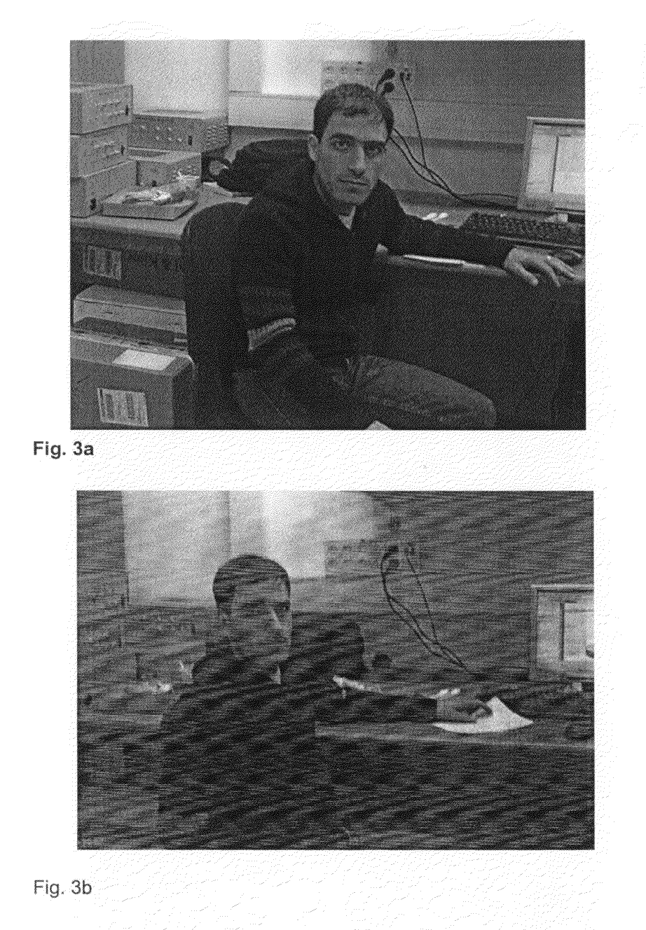

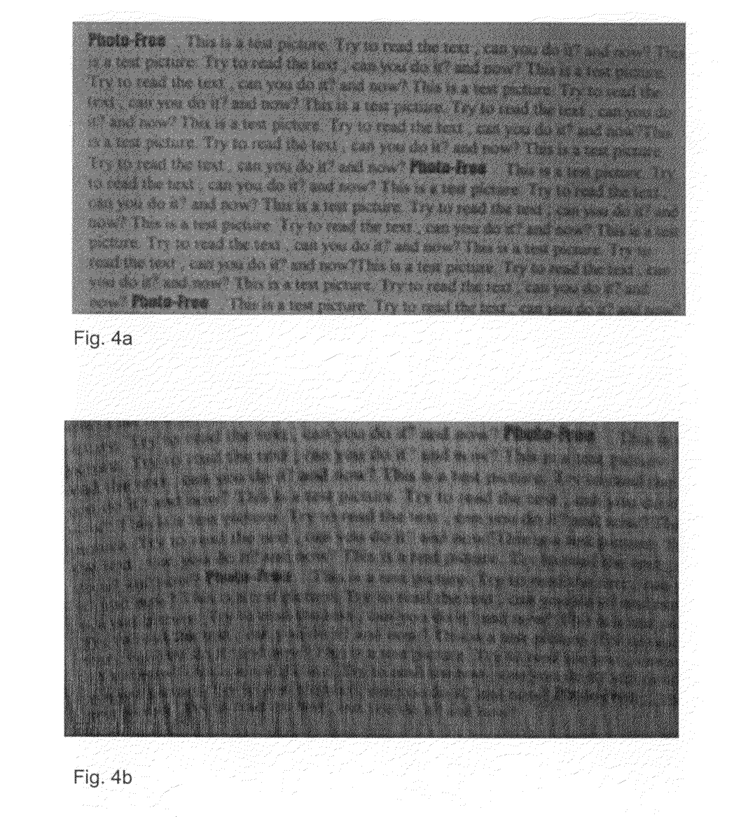

Although in the Proof of Concept FIGS. 3a, 3b, 4a and 4b hereinbelow, the disruptions applied were sinusoidal, it will be appreciated that preferably non-cyclic waves with complex waveforms, such as random square waves are used to prevent the noise being removed and the signal being cleaned up to give an undistorted image.

Although not specifically directed at preventing filming of a projected movie, it will be appreciated that the present invention could be used for this application as well.

Proof of Concept

By spectrum analysis across the radio frequencies of the electromagnetic spectrum, the radio frequencies that the electronic components of selected digital cameras are sensitive to were identified. A signal generator for generating the identified frequencies was provided and an antenna for transmitting the identified radio frequency was constructed and connected to the signal generator with a transmission line. Inhibitions coordination was performed to achieve the maximum power.

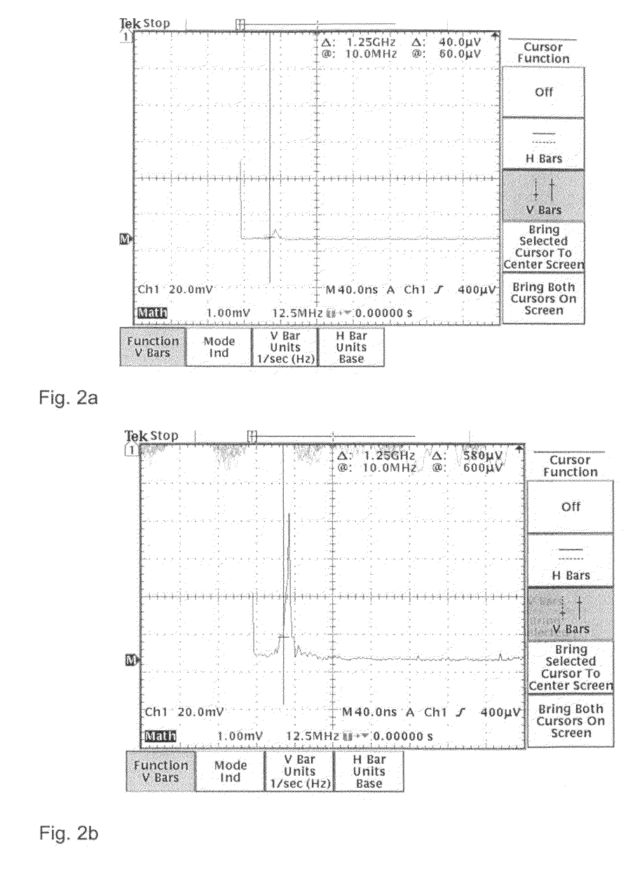

With reference to FIGS. 2a and 2b, one digital camera of the CCD type has been determined as having a high sensitivity to 13.6 MHz noise.

With reference to FIGS. 3 and 4, when the camera was exposed to a random 13.6 MHz noise a video image FIG. 3a taken by camera was distorted to give the blurred image of FIG. 3b, and still image 4a was blurred to give still image 4b.

Distorted images 3b and 4b were distorted by a simple sinusoidal wave and the distortion is wavelike and regular, and the digital signal cam fairly easily be cleaned to remove the distortion. In practical systems complex wave forms such as random square waves and white noise are transmitted, making cleaning up of the signal effectively impossible.

It appears that the component within the digital camera whose functioning was disrupted was the CCD image sensor. The display screen (LCD) was not disrupted during the transmission unless the camera was actually filming and the signal viewed passed through the disrupted CCD or CMOS. From experimentation, it appears that the electronic sampling rate (register clock) of the pixilated arrays of CCD and CMOS elements of digital cameras operate at a frequency of 13.6 MHz. Exposing digital cameras to radiation at this frequency distorts the correct operation of and the photography performed by the digital camera without damaging the camera.

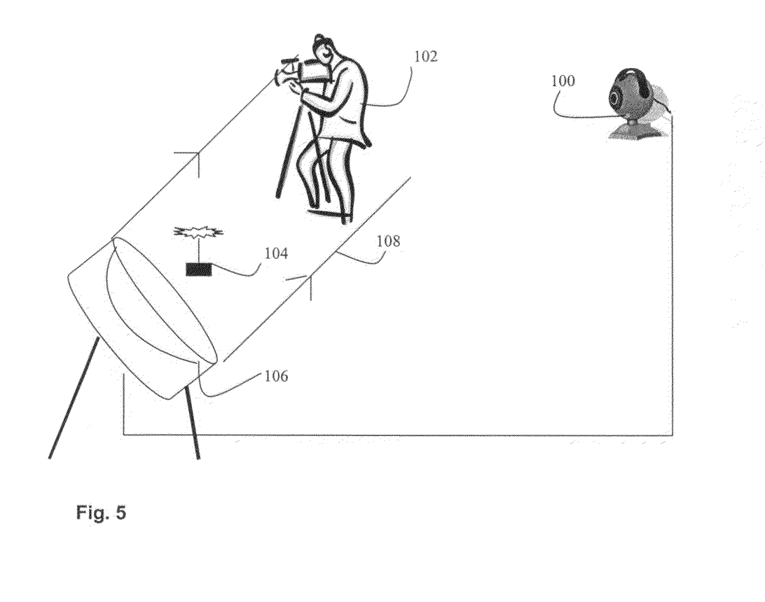

With reference to FIG. 5, a system for protecting a premises may include a means of detecting 100 for detecting a target 102 such as an intruder, an unwanted observer or a digital camera, either by detecting the characteristic emittances of digital cameras, such as the clock registry, or by visibly locating the photographer with a movement sensor, an optical imaging system with human observers or automatic image analysis to detect a suspected photographer. Once detected, a transmitter 104 at the focus of a parabolic reflector 106 can be used to direct an interference beam 108 at the target 102. The interference beam 108 typically comprises radio waves of appropriate characteristics to disrupt imaging of digital cameras, and preferably includes white noise or square waves of a 13.6 MHz frequency.

The present technology is capable of widespread application and can be installed to prevent photography in changing rooms in clothing stores and public toilets, and at swimming pools. Portable versions, perhaps designed to resemble mobile phones or even being mobile phones, with additional functionality might be carried around with celebrities and politicians. To prevent industrial espionage, systems could be installed in photofree areas of offices, conference rooms, factories and laboratories.

Systems of the invention will work instead of or in addition to prior art solutions to prevent recording of screened movies. Copyright may be protected in museums and art galleries a well. The system also finds security application in banks and military installations.

Thus persons skilled in the art will appreciate that the present invention is not limited to what has been particularly shown and described hereinabove. Rather the scope of the present invention is defined by the appended claims and includes, both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for causing the localized malfunctioning of a digital camera in a specified area to degrade photographic recording by the digital camera, comprising the steps of coupling the digital camera to a source of electromagnetic interference and generating electromagnetic waves of a frequency to interfere with the correct functioning of at least one electronic component of the digital camera.

2. The method of claim 1, the digital camera being selected from the list of still cameras, video cameras and digital cameras incorporated into cell phones.

3. The method of claim 1, the source of electromagnetic interference being a signal generator.

4. The method of claim 1, the digital camera being coupled to the source of electromagnetic interference by a coupling mechanism selected from the list of inductively coupling by a magnetic field, capacitively coupling by an electric field and radiatively coupling by an electromagnetic field.

5. The method of claim 1, the digital camera comprising at least one photoelectric element.

6. The method of claim 5, the photoelectric element selected from the list of CMOS and CCD elements.

7. The method of claim 1, the specified area being selected from the list of military installations, security installations, entertainment venues, proximity of a celebrity, business venues.

8. The method of claim 1 wherein the specified location is in proximity of a person and the signal generator and transmitter are portable with that person.

9. The method of claim 1 wherein the specified location is fixed and the signal generator and transmitter are installed in that specified location.

10. A method of selecting frequencies for blocking the operation of a digital camera comprising the steps of (i) Positioning a digital camera in proximity to a transmitter, such as at an electromagnetic compatibility testing site, (ii) Transmitting electomagnetic signals stepwise through radiofrequency section of electromagnetic spectrum to identify specific radio frequencies capable of distorting images; (iii) Constructing a signal generator capable of generating the distorting electomagnetic signals; (iv) Constructing an antenna for transmitting the generated signals, (v) Coupling the antenna to the signal generator by a transmission line, and (vi) Adjusting signal intensity to produce appropriate blocking signals over the desired space where digital photography is to be prohibited.

11. The method of claim 10 wherein the signal generator and transmitter are portable and are moved together with a celebrity to prevent illicit photography of the celebrity.

12. A system for interfering with correct operation of a suspected digital camera at a targeted location comprising a detecting means for detecting the target, a transmitter of blocking radiation a directing means for directing the blocking radiation at the target.

13. The system of claim 12 wherein the detecting means comprises a listening means for detecting audible shutter clicking sounds.

14. The system of claim 12 wherein the detecting means detects electromagnetic emissions of the digital camera.

15. The system of claim 14 wherein the electromagnetic emissions are clock registry emissions of a pixilated array.

16. The system of claim 12 wherein the transmitter is a RF transmitter for transmitting MHz RF signals.

17. The system of claim 12 wherein the directing means comprises a parabolic reflector.

18. A method of interfering with the operation of a digital camera comprising the step of: (c) transmitting electromagnetic radiation that interferes with correct functioning of the digital camera.

19. The method of claim 18 comprising the preliminary steps of: (a) locating the digital camera and (b) lining up a transmitter with the digital camera, where step (c) of transmitting an electromagnetic wave is comprises transmitting a directed radio transmission towards the digital camera.

20. The method of claim 18 wherein the transmitted electromagnetic radiation comprises radiation of a frequency of approximately 13.6 MHz.

21. The method of claim 18 wherein the transmitted electromagnetic radiation comprises white noise or complex waveforms.
